(19) United States
(12) Patent Application Publication
(10) Pub. No.: US 2012/0324885 A1
(43) Pub. Date: Dec. 27, 2012

(54) GEOTHERMAL POWER PLANT UTILIZING HOT GEOTHERMAL FLUID IN A CASCADE HEAT RECOVERY APPARATUS

(75) Inventors: Thomas L. Pierson, Sugar land, TX (US); Guofu Chen, Missouri City, TX (US)

(73) Assignee: Turbine Air Systems Ltd., Houston, TX (US)

(21) Appl. No.: 13/169,620

(22) Filed: Jun. 27, 2011

(51) Int. Cl. F03G 7/00; F01K 23/06; F01K 7/34

(52) U.S. Cl. 60/641.2; 60/653; 60/670

(57) ABSTRACT

A geothermal power system includes a steam turbine and a closed loop working fluid system having a preheater, a vaporizer, a superheater, an expander, a condenser, and a pump and a working fluid disposed to pass sequentially through the preheater, vaporizer, superheater, expander, condenser, and pump. Geothermal fluid is separated into a steam stream and a brine stream. The steam is expanded across the steam turbine to generate power, and thereafter exhaust from the steam turbine passes through the vaporizer to vaporize the working fluid. Geothermal brine is first used to heat vaporized working fluid in the superheater and is then used to preheat liquid working fluid in the preheater.

### BACKGROUND OF THE INVENTION

1. Field of the Invention

The present invention generally relates to an apparatus and method for producing power using geothermal fluid in an Organic Rankin Cycle (“ORC”) system, and more particularly, to an apparatus and method to optimize heat release from brine extracted from a geothermal reservoir and minimize the ORC system equipment.

2. Description of the Related Art

In general, there is a constant drive to increase the operating efficiency of geothermal power plants. Geothermal fluid recovered from a geothermal reservoir typically contains a mixture of steam and hot liquid. The liquid is often in the form of brine. In many high temperature brine geothermal fields, the prior art practice has been to flash the steam at a lower pressure and separate the geothermal steam from the geothermal brine and utilize the steam in a steam turbine power system. Specifically, power was produced by using the steam in a traditional steam turbine while the hot brine along with the condensed steam condensate was generally returned back to the ground to replenish the geothermal field. For lower temperature fields, the use of a binary Organic Rankin Cycle (“ORC”) power system often utilize heat extracted from the hot brine to vaporize an organic working fluid, which in-turn drives a turboexpander/generator. More recently there has been limited use of a combined cycle approach, whereby the separated incoming hot brine is used to provide heat to a superheater of an ORC system before being returned back to the ground, while the steam is used in a conventional steam turbine. In these prior art systems, the exhaust steam from the steam turbine is first used to vaporize a preheated organic working fluid and then to preheat the working fluid. One drawback to the systems of the prior art is that they are inefficient in some applications in that they do not fully utilize the brine heat, particularly in geothermal fields where a significant amount of the extracted fluid's heat is contained in the brine. In other words, the prior art systems are more useful for “steam dominant” resources but are less effective in geothermal fields where a greater portion of the heat may be carried by the brine. For “brine dominant” resources, the prior art utilized ORC systems without a steam turbine topping cycle or the prior art utilizes more complex ORC designs such as multiple ORC systems or additional heat exchangers, thereby requiring more equipment and expense. Therefore, there is a need for a more efficient geothermal ORC power plant that maximizes use of heat from the steam as well as the extracted brine while minimizing the need for multiple ORC systems, reduces the number of turboexpanders and reduces the number of heat exchangers required for efficient operation of the power plant while also reducing the heat exchange path required for the steam condensate flow.

### SUMMARY OF THE INVENTION

The present invention improves upon the prior art by allowing a more efficient means of using heat release curves from the separated steam and hot brine streams, thereby minimizing the need for multiple ORC systems and the number of heat exchangers through which the steam and hot brine must flow. More specifically, the present invention is generally directed to an improved method for recovering heat from a combined steam/hot brine resource by separating the steam from the hot brine and then utilizing the steam first to drive a steam turbine and then, utilizing the steam turbine exhaust, to provide heat to the working fluid vaporizer heat exchanger, which vaporizer is preferably sized to absorb enough heat from the steam turbine exhaust that the cooled steam condensate leaving the vaporizer may be returned to the ground without having to pass through any additional heat exchangers. The separated hot brine is utilized first to provide heat to the superheater through which vaporized working fluid passes and then to provide additional heat to the working fluid preheater, both of which are preferably sized so as to maximize heat extraction from the brine before the subcooled brine from the preheater is returned to the ground. Because the preheater extracts such a large amount of the remaining usable heat, the subcooled brine can be directly injected into the ground without the need to pass the brine through additional heat exchangers. Preferably, the vaporizer is sized to utilize most of the remaining heat in the steam condensate, such that there is no need to pass this steam condensate leaving the vaporizer though any additional heat exchangers. The condensed steam from the vaporizer may be mixed with the subcooled brine leaving the preheater and this mixed fluid stream may then be reinjected back into the reservoir to maintain hydraulic pressure. An important aspect of the invention is that the sizing of the heat exchangers, as well as the arrangement of the sequence of flow of all three fluids (separated brine, separated steam, and working fluid) must be accomplished in such a way that the heat from the geothermal liquid, as well as the heat contained in the separated steam, are utilized to closely match the heat release curve of the working fluid as discussed below. An additional advantage of using all of the steam condensate heat in a single heat exchanger, i.e., the vaporizer, rather than combining this condensate with the separated brine (to then flow as a combined stream through other heat exchangers) is that combining the streams would require equivalent pressure for both the steam condensate and brine, which requirement would restrict the operating conditions available to those two streams and result in a less optimized system.

### BRIEF DESCRIPTION OF THE DRAWINGS

The invention may be understood by reference to the following description taken in conjunction with the accompanying drawings, in which like reference numerals identify like elements, and in which:

FIG. 1 is a heat release curve.

FIG. 2 is a schematic diagram of one illustrative embodiment of the present invention showing a combined steam turbine and ORC with sequential heat release of brine temperature through a working fluid superheater and then a working fluid preheater.

FIG. 3 is a schematic diagram of another embodiment of the present invention which utilizes a recuperator.

### DETAILED DESCRIPTION OF THE INVENTION

According to Carnot Cycle theory, whenever there is a heat Q transferred from the hot temperature Th reservoir to cold temperature Tc reservoir, the Exergy E, the available energy that can be converted into power rather than heat, is defined by the following formula:

$$E = Q \times ( 1 - \frac{{T}_{c}}{{T}_{h}} ) \qquad Equation 1$$

If the cold reservoir is at atmosphere temperature T0, the hot reservoir temperature is T1, and Exergy is E1, then the formula becomes:

$${E}_{1} = Q \times ( 1 - \frac{{T}_{0}}{{T}_{1}} ) \qquad Equation 2$$

Similarly, when heat Q is transferred from T2 (lower than T1) to T0 then,

$${E}_{2} = Q \times ( 1 - \frac{{T}_{0}}{{T}_{2}} ) \qquad Equation 3$$

Then during the heat transfer process from T1 to T2, an Exergy loss occurs.

$$\begin{matrix}{E}_{loss} = {E}_{1} - {E}_{2} \\ = Q \times ( 1 - \frac{{T}_{0}}{{T}_{1}} ) - Q \times ( 1 - \frac{{T}_{0}}{{T}_{2}} ) \\ = Q \times {T}_{0} \times \frac{{T}_{1} - {T}_{2}}{{T}_{1} \times {T}_{2}}\end{matrix} \qquad Equation 4$$

Based on the foregoing, it is clear that exergy loss is proportional to the temperature difference between the two heat transfer fluids. This suggests it is preferable to design a process where the heat exchanger system employs a tight approach throughout the temperature range to minimize the exergy loss.

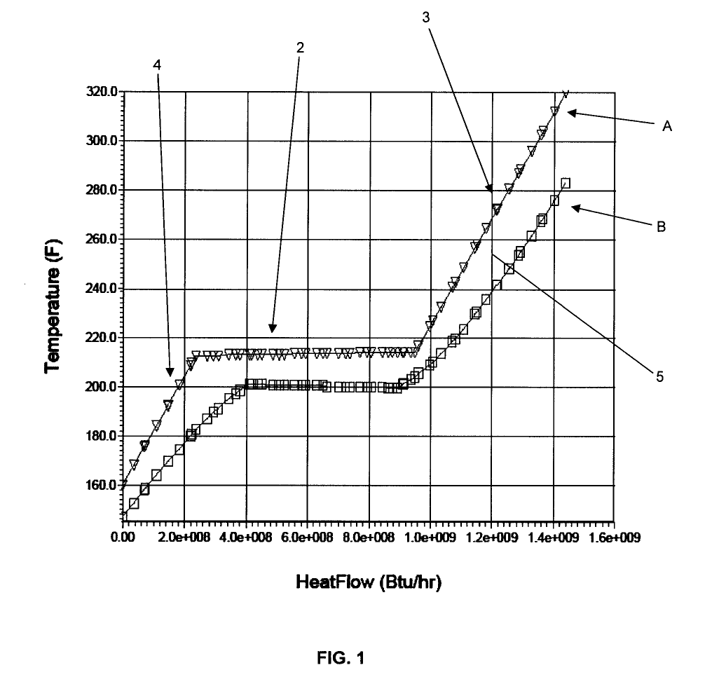

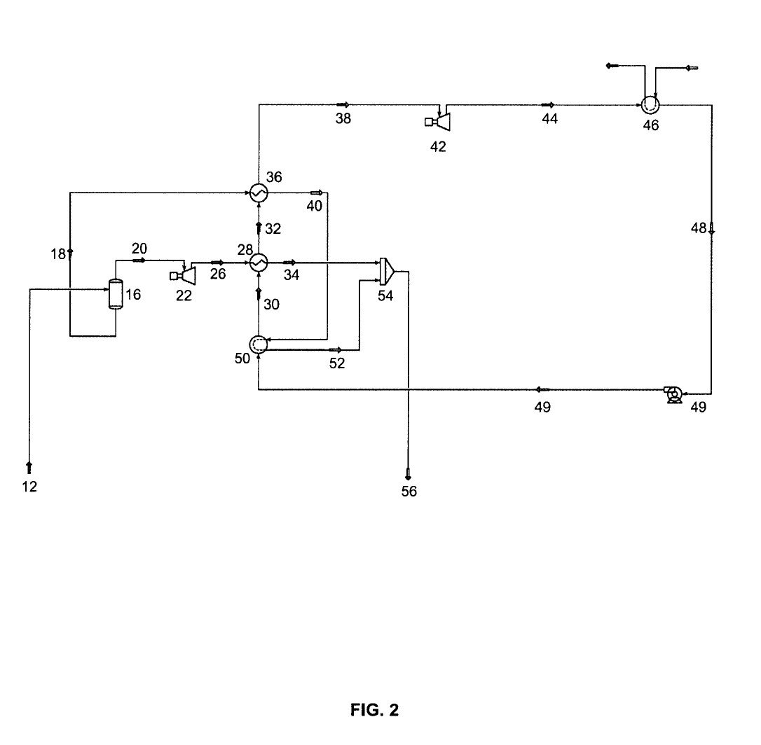

With reference to FIG. 1, there is shown a heat release curve generated with the process scheme described above. The top curve (with triangles) A represents the geothermal heat source composite or fluid (steam and liquid) heat release curve and the bottom curve (with squares) B represents the working fluid heat release curve of a system, such as for example an Organic Rankine Cycle system. With the process scheme shown before, the horizontal portion 2 of upper line A is the steam heat release in the vaporizer 28 (shown in FIG. 2 and discussed below); the slope portion 3 of line A above horizontal portion 2 is the brine heat release curve in the superheater 36 (shown in FIG. 2 and discussed below); and the slope portion 4 of line A below the horizontal portion 2 is the brine heat release curve in the preheater 50 (shown in FIG. 2 and discussed below). Curve B shows the heat release curve for a working fluid operating below its critical pressure. The area 5 between the two curves represents lost or unutilized heat.

With the process scheme described above, the objective of the invention is to arrange the preheater, vaporizer and superheater in such a way, and to design the heat exchanger surface area of all three of these exchangers, so as to optimize the temperature match between the heat source fluid and the working fluid throughout the temperature gradient so as to transfer as much heat as possible to the working fluid system for a given amount of heat exchanger surface area since this relates to cost. In other words, the preheater, vaporizer and superheater are designed and arranged so curve A and curve B match one another as much as possible to minimize the area between the two curves (5) while maintaining an approximately equal temperature difference between curve A and curve B throughout the entire heat exchange process. This will reduce the lost heat energy for a given amount of heat exchanger area thus maximizing utilization of heat from the available heat source and resulting in improved system performance. In one embodiment, the temperature difference between the two curves is no more than 20%, and in another preferred embodiment, the temperature difference is no more than 10%.

Referring to FIG. 2, a power system generally includes a steam turbine (22) across which steam is expanded and an expander (42), such as an additional turbine, across which a working fluid is expanded. In one embodiment of the invention, additional turbine (42) is utilized in conjunction with an organic working fluid power system, such as an Organic Rankine Cycle system. In any event, as shown, a geothermal fluid (12) from a geothermal reservoir is flashed and separated into a steam stream (20) and a hot liquid stream (18) utilizing separator 16. Those skilled in the art will appreciate that the liquid stream may be any liquid recovered from a geothermal reservoir, but is most commonly water having various minerals dissolved therein, and for purposes of this description, will be referred to as brine. Likewise, while liquid stream 18 is described as a liquid, those skilled in the art will appreciate that stream 18 is all or predominantly liquid, but may have a small gaseous portion, such as steam. As such, references to stream 18 are intended to encompass any stream that is predominantly liquid. The hot brine stream 18 is supplied to heat exchanger (36), namely, a superheater, where a portion of the thermal energy of stream 18 is used to heat the working fluid (38) of a separate system. In the preferred embodiment, superheater (36) is disposed to convert a vaporized working fluid (32) into a superheated working fluid (38). The partially cooled brine stream (40) leaves the superheater (36) and is then supplied to heat exchanger (50), namely a preheater, where heat from cooled brine stream (40) is used to preheat the incoming condensed working fluid (49) prior to the preheated working fluid (30) entering heat exchanger (28), namely a vaporizer.

The steam stream (20) leaves separator (16) and is first expanded in a steam turbine (22) to produce power. The steam turbine exhaust (26) is used to provide heat to vaporizer (28), which will heat and vaporize preheated working fluid (30) to produce vaporized working fluid (32). The steam turbine exhaust (26) upon cooling in vaporizer (28) is condensed back into steam condensate (34). The vaporizer heat exchanger (28) is preferably sized to extract a majority of the useful heat contained in steam turbine exhaust (26) such that the steam condensate (34) leaving the vaporizer (28) may be reinjected back into the ground without the need for further cooling, i.e., stream (34) need not be passed through additional heat exchangers before reinjection into the ground. The working fluid, which is preferably a fluid other than water, such as an organic fluid, is thus heated in three separate, sequential stages, which stages are arranged to maximize the heat release curve in all three heat exchangers.

More specifically, with continued reference to FIG. 2, in the working fluid power system, a condensed working fluid (49) from a condenser (46) is first heated in a first heat exchanger, namely preheater (50), by the partially cooled brine stream (40) so as to raise the sensible temperature of the condensed working fluid (49) to a higher temperature, resulting in preheated working fluid stream (30). This preheated working fluid (30) is then directed into a second heat exchanger, namely vaporizer (28), where the preheated working fluid stream (30) is heated until it changes phase to a vapor by the heat that is provided to the vaporizer (28) from the steam turbine exhaust (26). The vaporized working fluid (32) is then directed into a third heat exchanger, namely superheater (36), where additional heat from the hot brine (18) is added to the vaporized working fluid (32), so as to produce a superheated working fluid (38). The superheated working fluid (38) is then expanded in working fluid expander (42) to produce rotational energy which may be used drive a generator.

In one embodiment, the expanded working fluid (44) is then directed to a condenser (46), where the working fluid will be condensed. Although not intended as a limitation of the invention, condenser (46) may utilize heat transfer with ambient air or from water or similar device to transfer heat from the expanded working fluid (44) to the ambient atmosphere. Alternatively, this heat may be utilized in a separate process which utilizes the rejected heat. In any event, the condensed working fluid (48) is circulated by a pump (49) back to the preheater (50) to repeat the process.

The subcooled brine (52) leaving the preheater (50) may be reinjected back into the reservoir along with the steam condensate (34) to help maintain the reservoir pressure. This reinjection may occur in two separate reinjection wells, or preferably, the subcooled brine (52) and the steam condensate (34) will be mixed together at 54 so they may be reinjected as a single stream into one or multiple reinjection wells (56). Those skilled in the art will appreciate that the arrangement of the three heat exchangers as described above maximizes heat transfer from geothermal fields where geothermal liquid is the dominant heat storage fluid of the field through the circuiting of the steam turbine exhaust and the hot brine so as to best match the heat release curve. Although not intended as a limitation of the invention, those skilled in the art will further appreciate that all three of the heat exchangers of the system, namely the preheater, the vaporizer, and the superheater, are preferably sized such that the differences in the heat release curves can be minimized and such that the most effective heat transfer can occur with the available exchanger surface area, thereby minimizing the need for additional heat exchangers.

In one preferred embodiment, the working fluid is contained in a closed loop system, such as for example, an ORC system. In one preferred embodiment, the working fluid is a refrigerant other than water. In another preferred embodiment, the working fluid is R-134a or R-245fa or ammonia. In another preferred embodiment, the working fluid is an organic fluid.

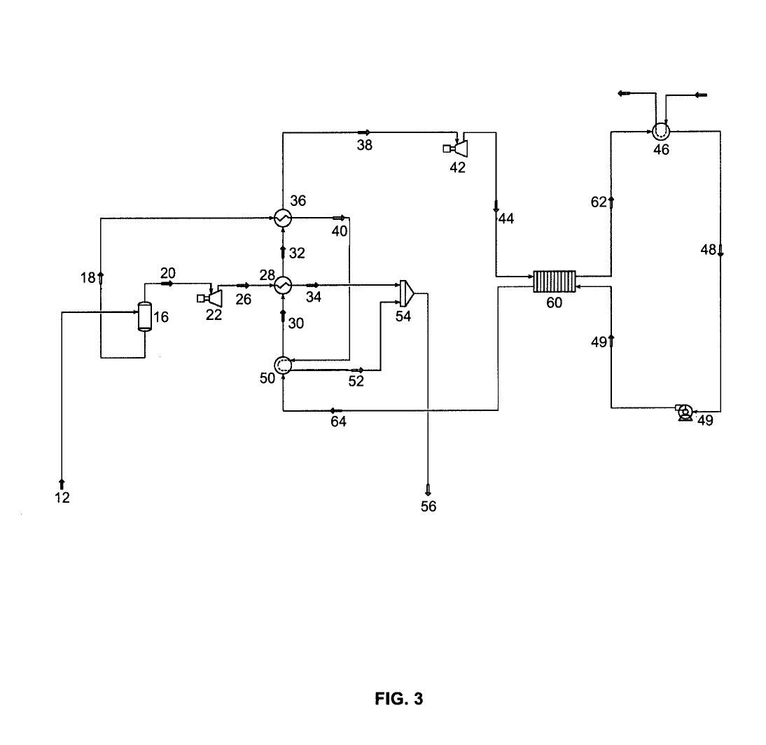

Referring now to FIG. 3, the process is similar to FIG. 2 described above except a recuperator (60) is used to reclaim additional heat from the expanded working fluid (44) after it leaves the working fluid expander (42). Recuperator (60) utilizes this residual heat to heat the condensed working fluid (48) leaving the condenser (46) so as to partially heat working fluid (64) before it is further heated in the preheater (50) by the partially cooled brine (40).

The system of the invention is particularly useful for geothermal fields where a significant portion of the field's heat is contained in hot liquid extracted, such as brine, from the field (as opposed to steam). In this regard, in certain embodiments, the system of the invention provides a “hot water dominant” system so as to maximize heat recovery from these types of geothermal fields.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

What is claimed:

1. A method for producing power from a geothermal fluid whereby the geothermal fluid is separated into a steam stream and a hot brine stream wherein:
a. expanding the steam stream across a first turbine and utilizing the first turbine to drives a generator to produce power;
b. directing exhaust from the first turbine into a vaporizer and utilizing the vaporizer to vaporize a preheated working fluid, thereby producing a vaporized working fluid and a steam condensate;
c. directing the hot brine stream into a superheater and utilizing the superheater to heat the vaporized working fluid leaving the vaporizer, thereby producing a superheated working fluid and a partially cooled brine;
d. expanding the superheated working fluid across a working fluid expander to produce an expanded working fluid and utilizing the working fluid expander to produce power;
e. condensing the expanded working fluid to produce a condensed working fluid;
f. pumping the condensed working fluid into a high pressure fluid through a pump;
g. directing the pumped high pressure working fluid into a preheater and utilizing the partially cooled brine from the superheater to preheat the condensed working fluid, thereby producing a preheated working fluid and a subcooled brine; and
h. directing the preheated working fluid from the preheater into the vaporizer.

2. The method of claim 1 wherein the working fluid is a refrigerant other than water.

3. The method of claim 1 wherein the working fluid is R-134a.

4. The method of claim 1 wherein the working fluid is R-245fa.

5. The method of claim 1, wherein the geothermal fluid is characterized by a heat release curve and the working fluid is characterized by a heat release curve, wherein the superheater, the vaporizer, and the preheater are sized to maximize the match between the heat release curves of the working fluid and the geothermal fluid.

6. The method of claim 1 further comprising the step of directing the expanded working fluid into a recuperator and utilizing the recuperator to remove heat from the expanded working fluid prior to condensing the expanded working fluid.

7. The method of claim 6, further comprising the step of utilizing the recuperator to heat the condensed working fluid prior to directing the condensed working fluid to the preheater.

8. The method of claim 1, wherein the steam condensate is injected into the ground immediately after passing through the vaporizer.

9. The method of claim 1, wherein the steam condensate is combined with subcooled brine after leaving the respective vaporizer and preheater and thereafter, injected into the ground.

10. The method of claim 1, wherein the subcooled brine is injected into the ground immediately after passing through the preheater.

11. A method for generating power, comprising:
a. extracting a geothermal fluid from a geothermal reservoir;
b. separating the geothermal fluid into a gaseous stream and a liquid stream;
c. directing the liquid stream first through a superheater and then through a preheater;
d. expanding the gaseous stream across a first turbine;
e. directing exhaust from the first turbine to a vaporizer;
f. directing a working fluid first through the preheater, then through the vaporizer and then through the superheater.

12. The method of claim 11, further comprising the step of expanding the working fluid across a second turbine after directing the working fluid through the superheater.

13. The method of claim 11, further comprising:
a. extracting heat from the expanded working fluid in a recuperator;
b. condensing the expanded working fluid following heat extraction in the recuperator; and
c. heating the condensed working fluid in the recuperator with the extracted heat.

14. A method of generating power comprising:
a. utilizing brine extracted from a geothermal reservoir to superheat a vaporized working fluid and thereafter, utilizing the brine to preheat a liquid working fluid; and
b. utilizing steam extracted from a geothermal reservoir to drive a turbine, and thereafter, utilizing the steam to vaporize the preheated liquid working fluid.

15. The method of claim 14, further comprising the step of utilizing the superheated vaporized working fluid to drive a turbine.

16. The method of claim 14, further comprising the step of combining steam utilized to vaporized the preheated liquid working fluid with brine utilized to preheat liquid working fluid and thereafter, injecting the combined steam and brine back into the geothermal reservoir.

17. An apparatus for generating power comprising:
a. a separator having a steam outlet and a liquid outlet;
b. first, second and third heat exchangers, each having a working fluid inlet and outlet and a heating fluid inlet and outlet;
c. a working fluid disposed to pass sequentially through the first, second and third heat exchangers;
d. a steam turbine having a steam inlet and an exhaust outlet, wherein the steam inlet is in fluid communication with the steam outlet of the separator;
e. a working fluid expander having a working fluid inlet and a working fluid outlet;
f. wherein the exhaust outlet of the steam turbine is in fluid communication with the heating fluid inlet of the second heat exchanger;
g. wherein the heating fluid inlet of the first heat exchanger is in fluid communication with the heating fluid outlet of the third heat exchanger, the working fluid inlet of the first heat exchanger is in fluid communication with the working fluid outlet of the working fluid expander and the working fluid outlet of the first heat exchanger is in fluid communication with the working fluid inlet of the second heat exchanger;
h. wherein the working fluid outlet of the second heat exchanger is in fluid communication with the working fluid inlet of the third heat exchanger;
i. wherein the working fluid outlet of the third heat exchanger is in fluid communication with the working fluid inlet of the working fluid expander, and the heating fluid inlet of the third heat exchanger is in fluid communication with the liquid outlet of the separator.

18. The apparatus of claim 17, further comprising
a. a condenser having a working fluid inlet and a working fluid outlet and
b. a recuperator having a gaseous inlet and gaseous outlet and a liquid inlet and liquid outlet,
c. wherein the gaseous inlet of the recuperator is in fluid communicating with the working fluid outlet of the working fluid expander, the gaseous outlet of the recuperator is in fluid communication with the working fluid inlet of the condenser, the working fluid outlet of the condenser is in fluid communication with the liquid inlet of the recuperator and the liquid outlet of the recuperator is in fluid communication with the working fluid inlet of the first heat exchanger.

19. The apparatus of claim 17, wherein the first heat exchanger is a preheater, the second heat exchanger is a vaporizer and the third heat exchanger is a superheater.

20. An apparatus for generating power comprising:
a. a separator;
b. a steam turbine;
c. a closed-loop working fluid system comprising a preheater, a vaporizer, a superheater, a working fluid turbine and a working fluid disposed to pass sequentially through the preheater, the vaporizer, the superheater and the working fluid turbine;
d. wherein the separator is in fluid communication with the superheater and the superheater is in fluid communication with the preheater; and
e. wherein the steam turbine is in fluid communication with the vaporizer.

21. The apparatus of claim 20, wherein the preheater and superheater further comprise a liquid heating fluid.

22. The apparatus of claim 20, wherein the closed-loop system further comprises a recuperator and the working fluid is disposed to pass from the working fluid turbine to the recuperator before returning to the preheater.

23. An apparatus for generating power comprising:
a. a steam turbine;
b. an ORC system having a preheater, a vaporizer, a superheater and a working fluid disposed to pass sequentially through the preheater, vaporizer and superheater;
c. means for passing a liquid heating fluid first through the superheater and then through the preheater; and
d. means for passing a steam turbine exhaust through the vaporizer.

24. The apparatus of claim 23, further comprising:
a. a separator means for separating fluid from a geothermal reservoir into a steam stream and a liquid heating fluid.

25. The method of claim 1 wherein the working fluid is ammonia.

26. The method of claim 5, wherein the match of the heat release curves is accomplished by designing the heat exchangers and fluid flow paths to maintain an approximately equal distance between the geothermal fluid heat release curve and the working fluid heat release curve throughout the entire heat release temperature range.

27. The method of claim 5, wherein each heat release curve is characterized by a temperature range and a select temperature at a select heat flow, and wherein the difference between the respective select temperatures at a select heat flow is substantially the same across the temperature range for the curves.
The method of claim 27, wherein the temperature difference is no more than 20%.
